(19) United States
(12) Patent Application Publication
(10) Pub. No.: US 2014/0310598 A1
(43) Pub. Date: Oct. 16, 2014

(54) Multimedia Spiral Timeline

(71) Applicant: OKAPPI, INC., Wilmington, DE (US)

(72) Inventors: Peter J. Sprague, Lenox, MA (US); Wayne D. Boyle, Selden, NY (US)

(73) Assignee: OKAPPI, INC., Wilmington, DE (US)

(21) Appl. No.: 14/152,671

(22) Filed: Jan. 10, 2014

Related U.S. Application Data
(60) Provisional application No. 61/751,164, filed on Jan. 10, 2013.

(51) Int. Cl. G06F 3/0484

(52) U.S. Cl. CPC G06F 3/04847
USPC 715/716

(57) ABSTRACT

Audio, video, or data spiral timeline display allowing a user to visually analyze, make decisions or perform actions with regard to multiple events over time in a compact display area. Due to the spiral display of data, more data and at higher detail can be displayed in a compact area, which may be particularly useful for mobile computing displays. The spiral timeline interface can provide the ability to analyze, make decisions or perform actions with regard to large amounts of events or over a large amount of time while still maintaining a view of the far extremes of the timeline.

This application claims the benefit of U.S. Provisional Application No. 61/751,164, filed on Jan. 10, 2013. The entire teachings of the above application is incorporated herein by reference.

### BACKGROUND

Visual audio, video, or data signal processing systems exist that allow a user to analyze, make decisions or perform actions with regard to audio, video, or data. Identifying events of interest (features of interest) within audio, video, or data streams can be difficult due to the quantity of this data and the lack of the ability to efficiently tag, segment, or index the data. While users want the ability to identify (in real time or after the fact) features of interest and determine interrelationships between features of interests in different audio, video, or data streams, the currently available timelines do not provide an efficient and user friendly solution for timeline processing.

### SUMMARY

While conventional timelines exist, they tend to suffer from several disadvantages in that they often provide a narrow field of view or display interface. In particular, such conventional timelines often allow a limited portion of the audio, video, or data timeline to be displayed into a given area. Further, if users would like to view timeline information beyond the viewable area, they often need to move the timeline left or right, taking the previous timeline area and audio, video, or data out of the users' view. When used with real time data streams, conventional timelines are dynamic, and as a result, they move sequentially in order for the user to view most current portion of the audio, video, or data stream. However, this real time movement also takes the previous timeline area and previous data out of the user's view, or compresses it so small that the audio, video, or data is not useable to the user. Further, conventional timelines tend to increase in size when there is more data to display or the time range is increased, unless they compress the audio, video, or data displayed, which can make it difficult for the user to read/use. For example, the display screens on devices such as on a mobile phone, a tablet, or a computer have limited space available to display timelines, and only a portion of a conventional timeline or a compressed and often unusable conventional timeline will appear on the device display screen.

The present invention overcomes the difficulty of the limited space available on and, in some cases, the limited size of the device display screens. Embodiments of the present inventions can provide a dynamic timeline that maximizes the field of view enabling the user to view and easily access previous portions of the timeline, as well as any current frames (if real time processing is used). This may be accomplished by first approaching the problem from the perspective that users are best served when they can view a maximum amount of audio, video, or data within a given area. This can particularly useful if the viewing screen has a relatively small display, such as cell phones or tablets. By presenting the audio, video, or data in a spiral form, the invention can provide the user with the ability to view more audio, video, or data in a given area. Typically, 8 times or more data can be displayed using the inventive spiral timeline interface. The inventive spiral timeline interface may further provide additional audio, video, or data information to be displayed allowing the user to analyze, make decisions, or perform actions, at a glance, while gaining access to much more audio, video, or data information.

In real time audio, video, or data display situations, an embodiment of the invention can configure the spiral timeline such that it displays new audio, video, or data, without compressing the visual of the timeline (or portions thereof).

If it is desired to view more or less audio, video, or data in detail, an embodiment of the invention may configure the spiral timeline to be rotated clockwise or counterclockwise (similar to turning the rings of the spiral like a knob) in order to change the time range of audio, video, or data that is displayed in the spiral. Each ring in the spiral timeline (or revolution in the spiral timeline) may represent a unit of time. In one example, each revolution may represent a half of an hour in the timeline. If the spiral timeline is turned in one direction, the amount of time represented on the timeline may be increased, and if turned in the opposite direction, the amount of time represented on the timeline may be decreased. By turning or twisting the rings of the spiral on a touch screen interface in either direction, a user may zoom in/out on the timeline to increase/decrease the time ratio represented by each ring in the spiral timeline. Preferably, this increase does not necessarily change the physical size or appearance of the spiral on the interface, but rather the unit of time represented by each circle/ring in the spiral timeline. The spiral timeline display area may be constant regardless of the amount, time, or time range, of audio, video, or data displayed, without having to compress the displayed audio, video, or data in the spiral timeline. In this way, the size of the spiral timeline on the interface may be static, while the unit of time represented by each circle/ring in the spiral (each revolution/cycle represented in the spiral) is variable.

In one embodiment, the spiral timeline may be implemented such that the entire spiral timeline represents a maximum time allotment (timeline ruler) for a reference period. The maximum time allotment may correspond to a specified amount of time available on the timeline for recording. This maximum time allotment may be configured in any number of ways. For example, the amount of recording time available shown on the maximum time allotment may be configured/set/controlled by the user, or it may function of (or directly correspond to) the storage space available via the computing (recording) device. In this way, the maximum time allotment may be a function of disk space measurement. An input signal or input stream represented on the timeline may be data that has been previously recorded (non-real time) or is being recorded in real time.

In some embodiments, an advancing portion of the input signal represented in the spiral timeline is represented on the spiral timeline using a first color, the first color being different from the color of the remainder of the spiral timeline. If the input stream represented on the timeline is being recorded in real time, it may be advancing, while being displayed over the maximum time allotment (reference period) represented by the spiral timeline. To show the incoming signal of audio, visual, or data being recorded, visual indicators on the spiral timeline, such as a change in color may be transposed over segments or portions of the spiral timeline may be provided as the input recording stream advances in time.

The juxtaposition of the input signal over the maximum time allotment over the spiral timeline reveals to the user an amount of time that has passed in relation to the overall maximum time allotted. Thus, the spiral timeline is configured to show to the user a comparison of the amount of time represented by the input signal in relation to the maximum time allotment. Further, a multitude of additional segments or signals may be displayed over both the maximum time allotment and current time signal(s), to represent segments of recorded or marked time. This provides a visual representation of a time frame, current time in relation to that timeframe, and indications of recorded events and event durations within those time frames.

A data processing system, method, computer program product or apparatus may be provided for representing an electronic input signal on a timeline. The input signal may be an audio, video or data signal. A display engine, for example, a touch interface, may be configured to generate a spiral timeline representative of an input signal. The spiral timeline may be configured to provide a representation of the input signal including parameters associated with the input stream including any of: time, current time, and a plurality of time segments. The spiral timeline interface may be configured to enable a user to access navigate to any portion of the input signal for playback. The spiral timeline may provide a representative depiction of the input signal without having to visually compress the input signal for display. In some embodiments, the spiral timeline provides a representative depiction of the input signal without having to compress the spiral timeline or portions thereof.

In some embodiments, the spiral timeline interface shows the current time by advancing the signal representation in the spiral timeline during real time signal capture.

The spiral timeline may be configured to show a plurality of time segments of the signal, such that the plurality of time segments represent defined portion(s) of the signal, which may be stored in permanent storage versus those portion(s) that are stored in temporary storage. A defined time segment in the spiral timeline may be defined by recorder markers signifying events in the signal. In other embodiments, the spiral timeline is configured to show a plurality of time segments of the input signal, such that each of the time segments represents the event identified in the segment of the input signal.

In certain embodiments, an event in a segment of the input signal is defined on the spiral timeline using markers input by the user, the markers defining a beginning portion of the segment and an end portion of the segment such that the event is marked in the input signal. In some embodiments, the permanent storage segment is represented by a first color on the spiral timeline, and the temporary storage segment is represented by a second color on the spiral timeline.

The spiral timeline may be configured to enable rotation clockwise or counterclockwise in order to change the time range of content in the signal being represented. In some embodiments, the spiral timeline may be configured to enable rotation clockwise or counterclockwise in order to change the time range of content in the signal being represented, such that the touch interface is configured to detect at least two fingers rotating on the touch interface.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a schematic diagram of a computer network environment in which embodiments are deployed.

FIG. 1B is a block diagram of the computer nodes in the network of FIG. 1A.

FIG. 2 is a detailed view of an embodiment of the present invention.

FIG. 3 is a detailed view of an embodiment of the present invention.

FIGS. 4A-4B are screenshots of an example interface implementation of the spiral timeline invention according to zoom in/out embodiments.

FIG. 4C is a screenshot of an example conventional timeline interface, which is corresponds to the spiral timeline interface according to an embodiment.

FIG. 4D is a screenshot of an example interface implementation of the file list for recordings stored in temporary memory/storage according to an embodiment.

FIG. 4E is a screenshot of an example interface implementation of the quick set interface for moving segments of the input signal from temporary memory/storage to permanent memory/storage according to an embodiment.

FIG. 5 is a flow diagram according to an embodiment of a method of the invention.

### DETAILED DESCRIPTION OF THE INVENTION

A description of example embodiments of the invention follows.

Digital Processing Environment

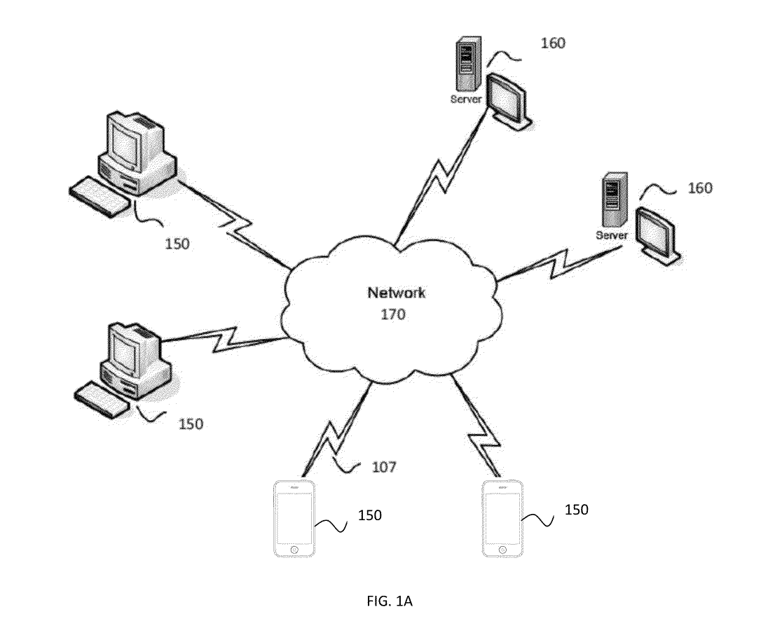

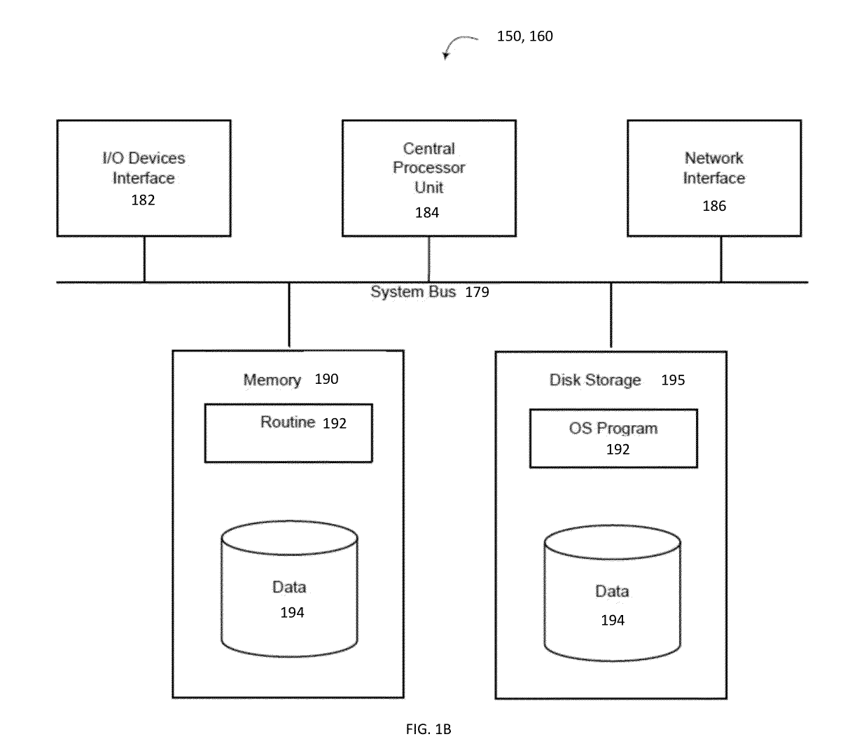

Example implementations of the present invention may be implemented in a software, firmware, or hardware environment. FIG. 1A illustrates one such environment. Client computer(s)/devices 150 (e.g. mobile phone) and a cloud 160 (or server computer or cluster thereof) provide processing, storage, and input/output devices executing application programs and the like.

Client computer(s)/devices 150 can also be linked through communications network 170 to other computing devices, including other client devices/processes 150 and server computer(s) 160. Communications network 170 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

Embodiments of the invention may include means for displaying audio, video, or data signal information. FIG. 1B is a diagram of the internal structure of a computer/computing node (e.g., client processor/device/mobile phone device/tablet 150 or server computers 160) in the processing environment of FIG. 1, which may be used to facilitate displaying such audio, video, or data signal information. Each computer 150, 160 contains a system bus 179, where a bus is a set of actual or virtual hardware lines used for data transfer among the components of a computer or processing system. Bus 179 is essentially a shared conduit that connects different elements of a computer system (e.g., processor, disk storage, memory, input/output ports, etc.) that enables the transfer of data between the elements. Attached to system bus 179 is I/O device interface 182 for connecting various input and output devices (e.g., keyboard, mouse, displays, printers, speakers, etc.) to the computer 150, 160. Network interface 186 allows the computer to connect to various other devices attached to a network (for example the network illustrated at 170 of FIG. 1A). Memory 190 provides volatile storage for computer software instructions 192 and data 194 used to implement a software implementation of the present invention (e.g. spiral timeline). If implemented in software, the spiral timeline interface described herein may be configured using any known programming language, such as any high-level, object-oriented programming language. In one example, a software implementation for OS X and iOS operating systems and their respective APIs, Cocoa and Cocoa Touch maybe implemented using Objective-C or any other high-level programming language that adds Smalltalk-style messaging to the C programming language.

Disk storage 195 provides non-volatile storage for computer software instructions 192 (equivalently “OS program”) and data 194 used to implement an embodiment of the spiral timeline of the present invention. Central processor unit 184 is also attached to system bus 179 and provides for the execution of computer instructions. Note that throughout the present text, “computer software instructions” and “OS program” are equivalent.

In one embodiment, the processor routines 192 and data 194 are a computer program product, display engine (generally referenced 192), including a computer readable medium capable of being stored on a storage device 195, which provides at least a portion of the software instructions for the spiral timeline invention system. The spiral timeline computer program product 192 can be installed by any suitable software installation procedure, as is well known in the art. In another embodiment, at least a portion of the spiral timeline software instructions may also be downloaded over a cable, communication and/or wireless connection. In other embodiments, the invention spiral timeline software is a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present spiral timeline invention routines/program 192.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is transmitted over the propagation medium over a period of time, such as the instructions for a software application sent in packets over a network over a period of milliseconds, seconds, minutes, or longer. In another embodiment, the computer readable medium of computer program product 192 is a propagation medium that the computer system 150 may receive and read, such as by receiving the propagation medium and identifying a propagated signal embodied in the propagation medium, as described above for computer program propagated signal product.

### Spiral Timeline Interface

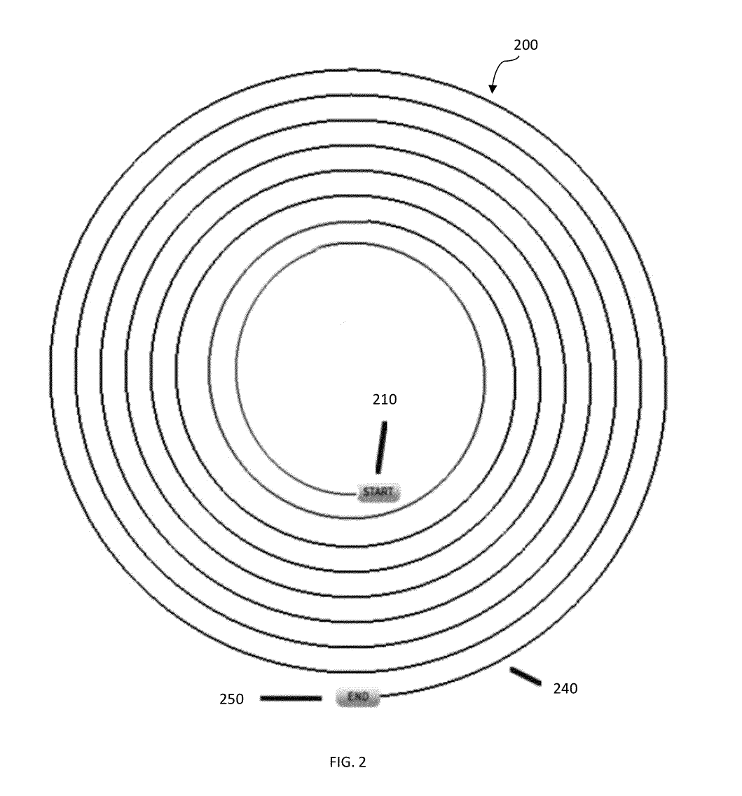

The present invention may be implemented as a display system for displaying audio, video, and data events over time. FIG. 2 is a detailed view of an embodiment of the spiral timeline 200 of the present invention. FIG. 2 shows the start point of the present spiral timeline 210 of the invention, and the end point of the spiral timeline 250, where the continuous spiral line 240 represents the maximum time allotment signal as a function of time. In some embodiments, the start point of the spiral timeline corresponds to the zero point of time.

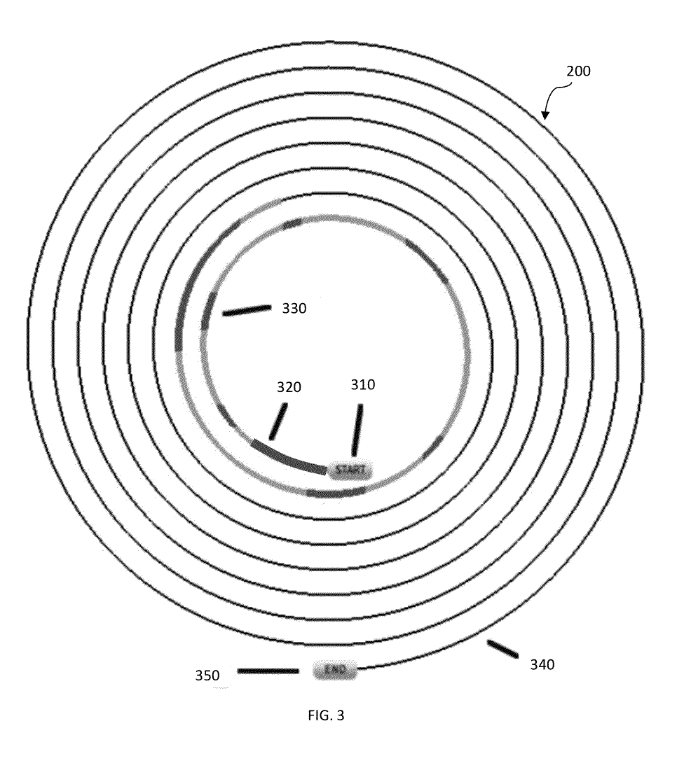

In more detail, referring to the invention of FIG. 3 showing an embodiment of the spiral timeline 200, there is shown the start point of the spiral timeline 310, and the end point of the spiral timeline 350, where the continuous spiral line 340 represents the maximum time allotment signal as a function of time, and a plurality of signals 330 representing time segments signals as a function of time, and signal 320 representing a current time signal as a function of time. In some embodiments, a plurality of time segments is the plurality of signals 330 representing a time segments signals as a function of time. In some embodiments, the plurality of time segments is a plurality of information segments over time periods.

By presenting the audio, video, or data in a spiral form, the invention can provide the ability to view more audio, video, or data in a given area. Typically, 8 times or more information can be displayed. The spiral interface may further provide additional audio, video, or data to be displayed allowing the user to analyze, make decisions, or perform actions, at a glance, while gaining access to much more audio, video, or data.

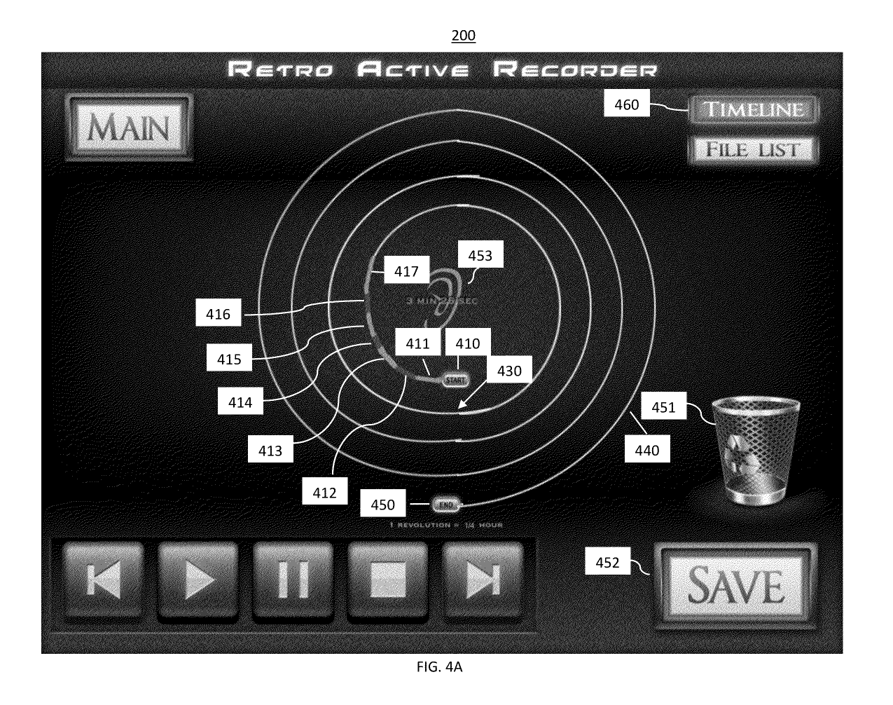

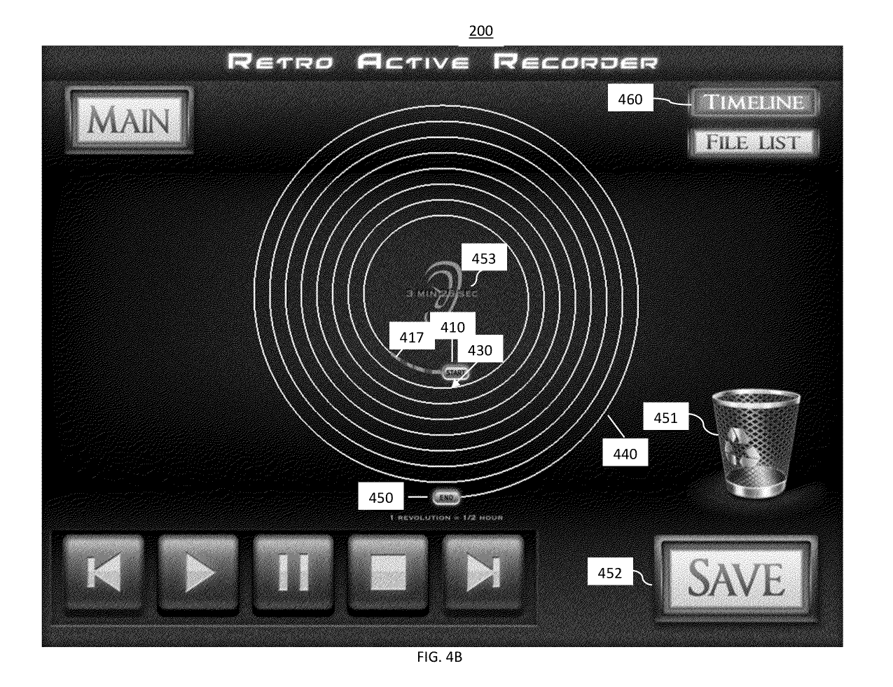

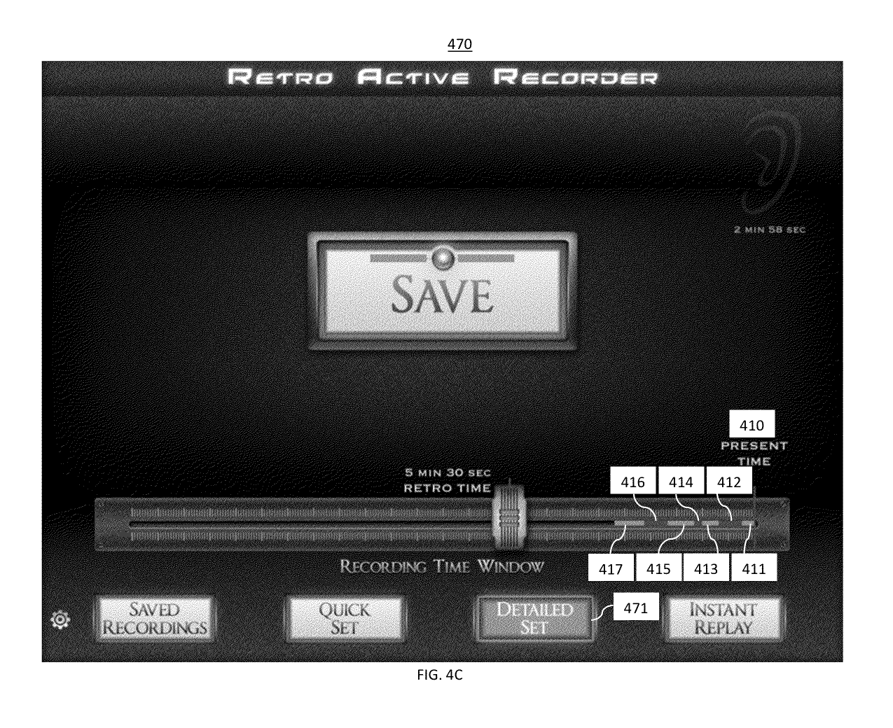

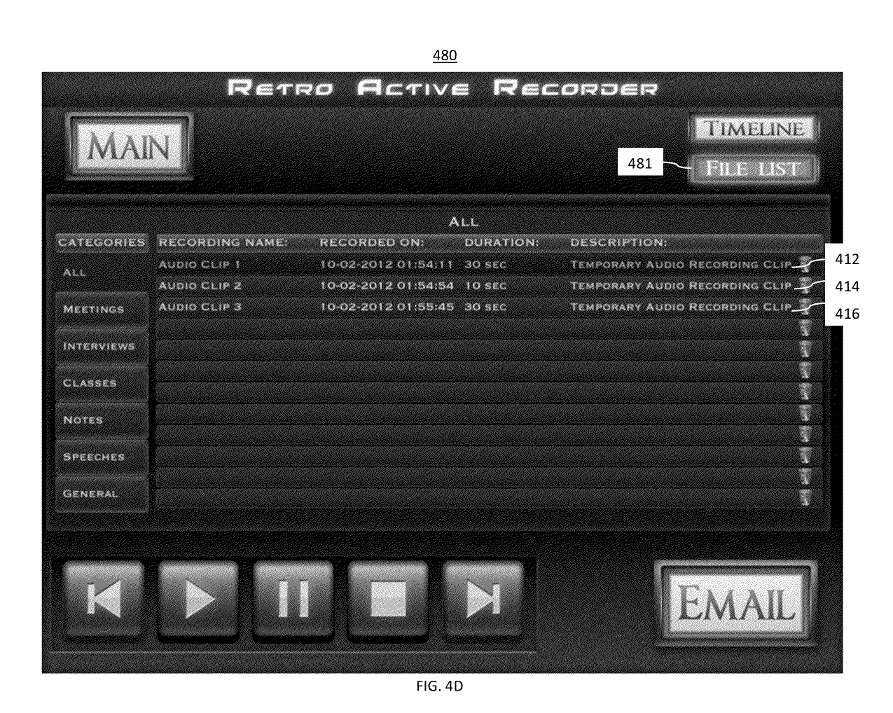

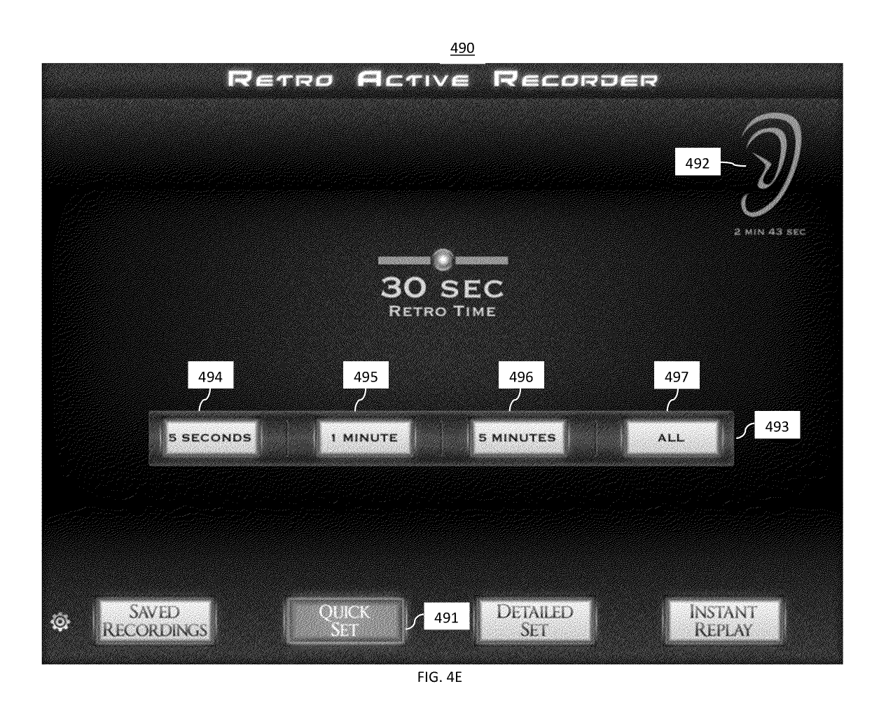

As shown in FIG. 4A, an embodiment of the spiral timeline 200, the entire spiral timeline (from “start” to “finish”) corresponds to the maximum time allotment 440 for recording the input stream. This maximum timeline allotment serves as the reference timeline. In this example, a single coil (or revolution in the spiral) of the timeline corresponds to ¼ of an hour (410 to 430), and the maximum time allotment is 1 hour (440).

The green and red segments in the hour long reference timeline represent those portions of the input stream which have been recorded either in temporary storage (shown in red, i.e., 412, 414, and 416) or permanent storage (shown in green, i.e., 411, 413, 415 and 417). The input stream or source clip (which is stored in both temporary shown in the red segments and permanent storage shown in the green segments) totals 3 minutes and 26 seconds in length, and the input signal is represented by the ear 453 in this FIG. 4A example. The green recorded segments in the spiral timeline are set using timeline markers indicating where events occur in the source clip, which are features of interest that should be stored in permanent storage. For example, the duration of events in the timeline may be identified and marked by a user by assigning a color for a segment of the audio, video, or data signal. The assigned color begins at the frame (time) the event was first marked in the audio, video, or data stream and ends at the frame (time) the event was last marked in the audio, video, or data stream. In this way, the user can easily mark and navigate to key frames or segments in the timeline and ensure that those key portions are stored to a permanent storage location for later use/analysis, while an unmarked portion of the input signal represented on the spiral timeline is stored in temporary storage as a temporary storage segment.

In some embodiments, a plurality of time segments can be copied or duplicated such that at least one copy of the time segment is stored in permanent memory or storage while at least one copy of the time segment is edited in temporary memory or storage. The edited duplicate or copy of the time segment can then be saved to permanent memory or storage as a new file or as a modified replacement of the copy of the time segment in permanent storage, e.g. overwriting and replacing the previous copy of the time segment in permanent storage. In some embodiments, the input stream, source clip, or main recording can be stored as one or more copies in both temporary memory or storage and permanent memory or storage. For example, recorded (non-real time or pre-existing) audio, video, or data information stored in permanent memory can be shown as green segments while real time audio, video, or data information can be shown as red segments. For example, a copy of the time segment or event in the spiral timeline may be generated by a user marking and assigning a color for a segment of the audio, video, or data signal. The assigned color begins at the frame (time) the event was first marked in the audio, video, or data stream and ends at the frame (time) the event was last marked in the audio, video, or data stream. In this way, the user can easily mark and copy or extract key frames or segments in the timeline and ensure that those key portions are simultaneously copied and stored to temporary storage and to permanent storage. The temporary storage copy of the time segment may allow the user to easily edit the temporary segment. The permanent storage copy of the time segment is unmodified until the user optionally chooses to save any changes to replace the permanent storage copy of the time segment with a modified version.

In some embodiments, the signal being processed is recorded (non-real time) audio, video, and data information, and the recorded information is displayed on the spiral timeline. In example embodiments, the user may recall a series of saved files and place or display the saved file data on the timeline. Thus, in some embodiments, the input signal is a series of recorded files. For example, the user has a series of camera video recordings that were made by multiple cameras at the same time. The user can then edit each video clip to ensure a complete continuous video. The user can see gaps, or missing segments, on the spiral timeline if the user does not have video for a segment of time. In example embodiments, the series of recorded files displayed on the spiral timeline allows the user to view a missing time segment on the spiral timeline.

In another embodiment, the spiral timeline displays recorded data. In example embodiments, the series of recorded files is displayed on the spiral timeline, such that each of the recorded files is displayed in a different color and overlapping time segments are displayed as an additive color. For example, if the user has voice to text recognition of audio streams, the user can place a marker at times when the user, system, apparatus, or method detects the word “bomb.” Multiple spiral timelines can be overlaid with additive colors so that when the word “bomb” is detected at a higher rate the user, system, apparatus, or method detects a brighter color on the spiral timeline. The brighter colored segment can be tapped or selected to hear the audio to determine the context in which the word was used. Thus in example embodiments, the additive color is displayed as a brighter color.

In some embodiments, an additive color results from a combination of multiple colors to create a new color. For example, an additive color of magenta results from combining or mixing red and blue; an additive color of yellow results from combining or mixing red and green; and an additive color of cyan results from combining of mixing blue and green. In example embodiments, Event Type A could be marked or represented by red segments, and Event Type B could be marked or represented by blue segments resulting in magenta segments on the spiral timeline denoting times when both events occur at the same time. Here, no magenta segments indicate that Event Type A and Event Type B did not occur simultaneously for any point in or period of time in the displayed spiral timeline. For example, if a user measures or records an input signal of a baseball being thrown, the baseball's time of arrival at home plate could be marked as Event A in Blue. The measurement or recording of the arrival time of the Batter's bat at the edge of home plate as Event B could be marked in Red. Any Magenta time segments in the spiral timeline would represent perfect contact with the ball. However, a spiral timeline displaying Red segments before Blue segments show the Batter swung too early, and Blue segments before Red segments show the Batter swung too late. Therefore, the displayed spiral timeline tracking Event A and Event B may give a very simple visual cue to the Batter to correct the timing of the swing of the bat. In other embodiments, additional events or multiple spiral timelines including other measurements such as height of the ball and height of the bat, etc. could each be displayed in different colors, so the user makes an analysis with visual cues in color rather than making an analysis with numbers and metrics. A spiral timeline with visual cues such as color may allow a user to make decisions regarding data with less processing required by the user. In some embodiments a visual cue is advantageous over processing a lot of information or raw data. For example, a clock/dial type speedometer or RPM gauge is better than a digital speedometer or RPM gauge because the user does not have to process details of interpreting numbers rather a glance at the location of a needle on a dial indicates speed or RPM of a vehicle.

In other embodiments, a signal is being processed in real time and then displayed on the spiral timeline. The user may mark sections of input to record in real time to display on the spiral timeline. The spiral timeline can show the user what audio, video, or data has been recorded, how long the recording has been going on, how much time remains in the maximum time allotment, etc.

If a signal is being processed in real time and then displayed on the spiral timeline, the spiral timeline may be configured to new portions of the input signal advancing on the spiral timeline, without having to visually compress other portions of the spiral timeline. In one example embodiment, even while the input stream advances on the spiral timeline in real time, the size (circumference of the outer edge) of the spiral timeline generally is static, while the time frame being represented is variable. This is advantageous for devices having small interfaces, such as mobile devices and tablets since the entire timeline can remain in the user's field of view. For example, while FIG. 4A shows each revolution in the spiral timeline representing 15 minutes, FIG. 4B shows a zoomed out version of the same spiral timeline in which each revolution in the spiral corresponds to ½ of an hour (410 to 430). Here, the general size of the spiral is static, while the number of cycles or curves in the spiral is variable and increases proportionally as a function of an increase in the maximum time allotment. For instance, the maximum time allotment 440 shown in the spiral timeline of FIG. 4A equals 1 hour, while the maximum time allotment 440 shown in the spiral timeline in FIG. 4B equals 4 hours. Likewise, the length of the green line (permanently stored segments of the input stream) is increased while zooming in as in FIG. 4A, while it is decreased while zooming out as shown in FIG. 4B (compare, for example, segment 417 in FIG. 4A versus FIG. 4B).

In one example embodiment, this rotated reduction/expansion of the timeline feature may be controlled by zooming in or out using a touch interface via a twist (knob) turning gesture with at least two fingers on the spiral timeline. For example, a touch interface may be configured to detect at least two fingers rotating on the touch interface (screen) to adjust the reduction/expansion of the spiral timeline accordingly.

In some embodiments, the touch interface or touch screen can detect at least one finger and a zoom gesture. A zoom gesture may include, for example, rotation of at least two fingers, distance changing between at least two fingers (two fingers spreading apart or two fingers closing together), a swipe up or swipe down with at least one finger, and a left swipe or a right swipe (left/right swipe) with at least one finger.

In some embodiments, the swipe up or swipe down motion to zoom in and to zoom out may be used for devices without a touch interface, for example, by using a mouse. In another example, plus or minus symbols, for example, as buttons or icons in a spiral timeline interface, may be used to implement the reduction/expansion features.

The time frame being represented in the spiral timeline may be variable, for example, with a zoom gesture. In some embodiments, the amount of time that the displayed spiral timeline represents may be adjusted by selecting a time range (frame). For example, the maximum time allotment shown in the spiral timeline equals 4 hours, and when a zoomed out version of the spiral timeline is display, for example, in FIG. 4B, the displayed spiral timeline corresponds to 4 hours. To display a spiral timeline that represents a 15 minute window within the maximum time allotment of 4 hours, a selection mechanism may allow selection of a zoomed in version of a 15 minute window of the spiral timeline. In example embodiments, a left/right swipe is used to move along the timeline of a zoomed in portion or version of the spiral timeline. For example, use a left/right swipe to go backward or forward to view 15 minute window versions of the spiral timeline within the maximum time allotment of 4 hours.

In certain embodiments, the zoom feature focuses on a selected recorded clip on the timeline, e.g., a green time segment. In an example embodiment, a green time segment is selected, and the zoom function is controlled by a zoom gesture of a left swipe or a right swipe with at least one finger. For example, the maximum time allotment shown in the spiral timeline equals 4 hours, and a 15 minute green time segment is displayed on the spiral timeline. The user can select, for example, by touching the 15 minute green time segment, which causes the 15 minute green time segment to be selected in memory. A zoom gesture, for example, rotation of at least two fingers or a left/right swipe, the zero point of time is set to the middle of the green recorded segment on the spiral timeline and allows a user to go forward or backward along the timeline.

Also shown in FIGS. 4A and 4B is a trash icon 451 in which segments of the timeline may be selected and drag/dropped to be discarded or moved into temporary storage. In this way, segments of the timeline which had been marked for saving to permanent storage (shown in green) may be conveniently moved to temporary storage. Also shown in FIGS. 4A and 4B is a save option (Save icon 452), which conveniently allows a user to move segments of the input stream that were stored in temporary storage (shown in red) to permanent storage (shown in green).

A conventional horizontal timeline may be optionally accessed, as well as a file list may be optionally accessed via the features provided at the upper right hand corner of the touch interface. For example, selecting the Timeline icon 460 of FIG. 4A or 4B allows optional access to a conventional horizontal timeline. One such conventional timeline interface is shown in FIG. 4C. As shown in FIG. 4C, a screenshot is provided of an example conventional timeline interface 470, which corresponds to the inventive spiral timeline interface according to an embodiment. The green and red segments in the recording time window of the conventional timeline interface 470 represent those portions of the input stream which have been recorded either in temporary storage (shown in red, i.e., 412, 414, and 416) or permanent storage (shown in green, i.e., 411, 413, 415 and 417). The Present Time 410 corresponds to the start point of a spiral timeline. The recording time window of the conventional timeline shows about 14 minutes of the timeline. The view of FIG. 4C corresponds to the Detailed Set view of a conventional timeline, denoted by the Detailed Set icon 471 being shown in blue.

FIG. 4D is a screenshot of an example interface implementation of the file list 480 for recordings stored in temporary storage/memory according to an embodiment. For example, the portions of the input stream recorded in temporary storage correspond to the red segments of the timeline (e.g., 412, 414 and 416 in some embodiments). The view of FIG. 4D corresponds to a File List view of a timeline, denoted by the File List icon being 481 shown in blue.

FIG. 4E is a screenshot of an example interface implementation of the quick set interface 490 for moving segments of the input signal from temporary memory/storage to permanent memory/storage according to an embodiment. The ear 492 represents the input signal and identifies the length of the signal. In this example, the input signal is 2 minutes and 43 seconds. The timeframe short cuts provided on the tool bar 493 in the center of the interface enable quick extraction of segments of the input signal from temporary to permanent memory (e.g. 5 seconds with icon 494, 1 minute with icon 495, 5 minutes with icon 496, and all with icon 497 are provided as timeframe options for extraction). The view of FIG. 4E corresponds to a Quick Set view of a timeline, denoted by the Quick Set icon 491 being shown in blue.

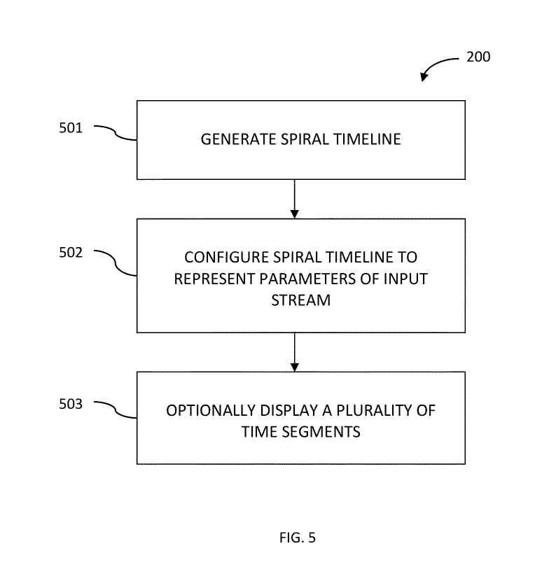

FIG. 5 is a flow chart of an example method of the invention to represent an input signal on an electronic interface. At step 501, the method generates a spiral timeline 200 that represents an input signal including an audio, video, or data signal on an electronic interface. At step 502, the method configures the spiral timeline to provide a representation of parameters associated with the input stream including any of: time, current time, and a plurality of time segments. Any or all of these parameters, such as a plurality of time segments at step 503, can be displayed in the spiral timeline interface.

### Example Implementations

Aspects of the inventive spiral timeline interface may be implemented using any device or system (e.g. FIG. 1A computer/device 150, 160) capable of recording or processing an audio, video, or data input file. Optionally, a retroactive recording system using features disclosed in U.S. Pat. No. 6,072,645, “Method and apparatus for retroactive recording using memory of past information in a data storage buffer,” filed Jan. 26, 1998, the entire teachings of which are incorporated herein by reference, for example, may be implemented using the spiral timeline. In an example mobile implementation, if a retroactive recording application is executed, the system may be configured to using a loop recorder implementation in which, upon execution, it automatically starts recording audio, video, or data content and stores the incoming input stream to a temporary storage location (cache). If the application is exited from or shut down, the input stream may be discarded. If the user executes the application again, it would automatically begin a new recording. If a user indicates that segment(s) of the input stream should be permanently recorded, then those segment(s) may be stored to a permanent storage location shown on the spiral timeline in a different color shade or using a transparency overlay on the respective portion of the spiral timeline (or shown in any other way capable of differentiating the recorded portions stored to temporary memory from those portions stored in permanent memory). In this way, the spiral timeline can be used to help easily distinguish portions of an input signal that are stored in temporary storage verses those portions that are stored in permanent storage.

The spiral timeline may be drawn (generated) on the interface using any method known to one of ordinary skill. For example, draw routines associated with the OS system's API or virtual machine may be called to draw the spiral from start to end. In one example implementation, the spiral may be drawn using a series of half circles (semi circles of varying sizes. Because the system may be constantly updating portions of the spiral to reflect events or changes to the input stream, the use of half circles to generate the spiral can be beneficial as it may require less system resources (and draw time) to update those portions of the spiral that have changed, as opposed to drawing and updating an entire circle in a series, or an entire spiral.

It should be noted that the references herein to “circles” should be interpreted to include quasi circles. For example, in generating the spiral, precise circles (or half circles) are not drawn via the draw routine because there are slight variances with each of the connected half circles in order to implement them into an integrated spiral shape. When a half circle is drawn using a draw routine via the API, for instance, a slight offset is added to ensure that the end point grows slight to connect the spiral.

Example features/comments from a non-limiting software code implementation are provided below:
Constants are first set up to define how the 3 line types are to be drawn.
Constants are also affected by device screen size, user interface style (V1, V2, etc.).
Maximum allowable time is represented in a White line, which is drawn first
Current time since the app was started is represented in a Green line, which is drawn second, on top of White line
Recording clips or other events are represented in a Red Line, which is drawn last, over both Green and White lines. There can be many red line segments.
All lines are drawn within a half circle segment. This provides faster drawing since the routine doesn't need to complete all half circles for green and red lines if there is no data to be displayed there

```
      // First set up the constants
      Degree_Angle = 90;  // // angle and direction determine how half
circle is drawn, i.e. top to bottom, or bottom to top
angle = (float)(Degree_Angle * ( (float)M_PI/180)); // float , in radians ,
```

The radian input should be the offset where the circle starts (the first segment).

```
      segments = 450;  // NSUInteger , how many segments are in
each half circle
      drawLineToCenter = NO; // BOOL
      //
      // Now set the colors for each line segment below
      cColor1.r = 0;  //G  Green used for current time
      cColor1.g = 255;  //R
      cColor1.b = 0;  //EE
      cColor1.a = 255;  //N
      //
      cColor2.r = 255;  //W  White used for overall / max time
      cColor2.g = 255;  //H
      cColor2.b = 255;  //IT
      cColor2.a = 255;  //E
      //
      cColor3.r = 255;  //R  Red used for recorded segments
      cColor3.g = 0;  //E
      cColor3.b = 0;  //D
      cColor3.a = 255;  //
      //
    //
      Loop_Dir_Temp = Loop_Dir_Temp + 1;
      if ( Loop_Dir_Temp > 1) { Loop_Dir_Temp = 0; }
      Loop_Temp = Loop_Temp + 1;
      } while ( Loop_Temp < 15 );
      // done drawing the first white line , complete spiral
      // 16 half circles total
      // for 4 hours , 14,400 seconds , each circle is ½ hr
      // 1800 seconds per circle
      // now draw the green line for current recorded timeline
      float HalfCircleTime = 1800 / 2;
      int Start_Offset = 0;  // start line after little start button
      // now show the current timeline over the white line in green
```

While this invention has been particularly shown and described with references to example embodiments thereof, it will be understood by those skilled in the art that various changes in form and details may be made therein without departing from the scope of the invention encompassed by the appended claims.

For example, it should be noted that although an Archimedean spiral is shown in certain figures to depict the spiral, any curve(s) which emanate from a central point, getting progressively farther away as they revolves around the point may be used to depict the spiral. Other forms of spiral configurations may be used, such as a Cornu spiral, Fermat's spiral, hyperbolic spiral, lituus, logarithmic spiral, or spiral of Theodorus.

It should also be noted that while the spiral timeline interface may be described in portions herein as showing a first input signal, one skilled in the art would appreciate that the interface may further show advantageously one or more further input signals. Such additional audio, video, or data feeds may be represented using different colors along the spiral (or via transparencies with layers). The use of a plurality of input feeds may be particular useful, for example, in the situation where multiple cameras are being used to film different angles/shots of the same event. In this way, the spiral timeline can be used to easily line up all the various input feeds and those feeds having shots or frames that are of particular interest can be easily marked as such (and stored to permanent storage), while others segments not of interest can be marked for temporary storage. In this way, a single combined stream can be integrated using the marked segments of interest from the various input streams.

Further, while the spiral timeline has been discussed in the context of providing a representation of data (in particular, audio, video, or data), other types of content may be represented by the spiral timeline interface. For instance, the spiral timeline may be used as an interface to represent files stored on a data storage device or disk (or any other electronic storage medium), from an image archive, or from a directory of electronic files. Different directories could each be represented by along the timeline, each varying by length based on file size.

In another example, the spiral timeline invention may be optionally implemented as an encoder interface to facilitate key frame marking and feature detection to facilitate encoding and compression optimization and management. In this way, one of ordinary skill would to be able to easily mark key frames for permanent storage for compression purposes, or identify features of interest, events, or areas of complexity in the input signal, frames or segments of which could be marked using colors for identification to be stored in permanent storage and/or for further processing.

While a preferred implementation of the invention is a spiral timeline interface on a mobile phone 150, the invention may be implemented on any computing device. In an example optional implementation, the spiral timeline could be implemented in an interface display for a digital camera computing device 150 for image, video, or audio capture. In this digital camera capture example, the user would be able to mark events (features of interest) in the incoming data stream advancing on the spiral timeline on the camera interface in real time. Other optional examples of a computer/device 150 in which aspects of the present invention may be implemented are shown in the Retroactive Recording Devices disclosed in U.S. Pat. No. 6,072,645, “Method and apparatus for retroactive recording using memory of past information in a data storage buffer,” filed Jan. 26, 1998, the entire teachings of which are incorporated herein by reference.

What is claimed is:

1. A data processing system for representing an audio, video, or data signal, the system comprising:
a) a touch interface configured to generate a spiral timeline representative of an input signal; and
b) the spiral timeline configured to provide a representation of the input signal including parameters associated with the input signal including any of: time, current time, and a plurality of time segments.

2. The data processing system as in claim 1 wherein a spiral timeline interface shows the current time by advancing the signal representation in the spiral timeline during real time signal capture.

3. The data processing system as in claim 1 wherein the spiral timeline provides a representative depiction of the input signal without having to compress the spiral timeline or portions thereof.

4. The data processing system as in claim 1 wherein the spiral timeline is configured to show the plurality of time segments of the input signal, such that each of the time segments represent an event identified in a segment of the input signal.

5. The data processing system as in claim 4 wherein the event in the segment of the input signal is defined on the spiral timeline using markers input by the user, the markers defining a beginning portion of the segment and an end portion of the segment, such that the event is marked in the input signal.

6. The data processing system as in claim 5 wherein the event marked in the input signal is saved as a permanent storage segment, while an unmarked portion of the input signal represented on the spiral timeline is stored as a temporary storage segment.

7. The data processing system as in claim 6 wherein the permanent storage segment is represented by a first color on the spiral timeline, and the temporary storage segment is represented by a second color on the spiral timeline.

8. The data processing system as in claim 1 wherein said spiral timeline is configured to enable rotation clockwise or counterclockwise in order to change a time range of content in the input signal being represented, such that the touch interface is configured to detect at least two fingers rotating on the touch interface.

9. The data processing system as in claim 1 wherein an advancing portion of the signal represented in the spiral timeline is represented on the spiral timeline using a first color, the first color being different from the remainder of the spiral timeline.

10. The data processing system as in claim 1 wherein the spiral timeline defines a maximum time allotment for the input signal, where the spiral timeline is configured to show to the user a comparison of the amount of time represented by the input signal in relation to the maximum time allotment.

11. A computer program product embodied on a non-transitory computer readable medium having computer readable instructions executable by one or more computer processors configured to represent an audio, video, or data signal on an electronic interface by
a) generating a spiral timeline representative of an input signal; and
b) directing a display of the spiral timeline on an electronic display interface such that it provides a representation of parameters associated with the input signal including any of the following parameters: time, current time, and a plurality of time segments.

12. The computer program product as in claim 11 wherein the spiral interface shows the current time by advancing the input signal representation in the timeline during real time signal capture.

13. The computer program product as in claim 11 wherein the spiral timeline provides a representative depiction of the input signal without having to compress the spiral timeline or portions thereof.

14. The computer program product as in claim 11 wherein the spiral timeline is configured to show the plurality of time segments of the input signal, such that each of the time segments represent an event identified in the signal.

15. The computer program product as in claim 14 wherein the event in the segment in the input signal is defined on the spiral timeline using markers input by the user, the markers defining a beginning portion of the segment and an end portion of the segment, such that the event is marked in the input signal.

16. The computer program product as in claim 15 wherein the event marked in the input signal is saved as a permanent storage segment, while an unmarked portion of the input signal represented on the spiral timeline is stored as a temporary storage segment.

17. The computer program product as in claim 16 wherein the permanent storage segment is represented by a first color on the spiral timeline, and the temporary storage segment is represented by a second color on the spiral timeline.

18. The computer program product as in claim 11 wherein said spiral timeline is configured to enable rotation clockwise or counterclockwise in order to change a time range of content in the input signal being represented.

19. The computer program product as in claim 11 wherein the spiral timeline defines a maximum time allotment for the input signal, where the spiral timeline is configured to show to the user a comparison of the amount of time represented by the input signal in relation to the maximum time allotment.

20. The computer program product as in claim 15 wherein the event marked in the input signal is saved as a permanent storage segment, and a copy of the event marked in the input signal is stored as a temporary storage segment for editing.

21. The computer program product as in claim 11, wherein the input signal is a series of recorded files.

22. The computer program product as in claim 21, wherein the series of recorded files displayed on the spiral timeline allows the user to view a missing time segment on the spiral timeline.

23. The computer program product as in claim 21, wherein the series of recorded files is displayed on the spiral timeline, such that each of the recorded files is displayed in a different color and overlapping time segments are displayed as an additive color.

24. The computer program product as in claim 23, wherein the additive color is displayed as a brighter color.

25. The computer program product as in claim 23, wherein the additive color is displayed as a result of a combination of multiple colors to create a new color.

26. A computer implemented method of representing an audio, video, or data signal on an electronic interface, the method comprising:
a) generating a spiral timeline representative of an input signal; and
b) configuring the spiral timeline such that it provides a representation of parameters associated with the input stream including any of: time, current time, and a plurality of time segments.
